(19) United States
(12) Patent Application Publication
(10) Pub. No.: US 2022/0348057 A1
(43) Pub. Date: Nov. 3, 2022

(54) Thermal Control System

(71) Applicant: Apple Inc., Cupertino, CA (US)

(72) Inventors: Scott Wujek, San Jose, CA (US); John M. Kearney, San Jose, CA (US); Kegan J. Connick, San Jose, CA (US); Nils Fredrik Magnus Wallin, Mountain View, CA (US)

(21) Appl. No.: 17/716,080

(22) Filed: Apr. 8, 2022

Related U.S. Application Data
(60) Provisional application No. 63/197,561, filed on Jun. 7, 2021.
(60) Provisional application No. 63/180,803, filed on Apr. 28, 2021.

(51) Int. Cl. B60H 1/00

(52) U.S. Cl. CPC B60H 1/00907; B60H 1/00207; B60H 2001/00214; B60H 2001/00242

(57) ABSTRACT

A thermal control system for a vehicle includes a first heat exchanger configured to thermally condition first intake airflow received at a first end of a vehicle cabin, a second heat exchanger configured to thermally condition second intake airflow received at a second end the vehicle cabin, a thermal loop circulating a working fluid between the first heat exchanger and the second heat exchanger, and a flow control system configured to cause the working fluid to circulate in opposite flow directions through the thermal loop for the first and second heat exchangers to operate in heating and cooling modes.

### CROSS-REFERENCE TO RELATED APPLICATION(S)

This application claims the benefit of U.S. Provisional Patent Application No. 63/180,803, filed on Apr. 28, 2021, and U.S. Provisional Patent Application No. 63/197,561, filed on Jun. 7, 2021, the contents of which are hereby incorporated by reference in their entirety for all purposes.

### TECHNICAL FIELD

This disclosure relates generally to thermal control systems and in particular to a thermal control system with a rear module and a thermal loop with a reversible direction of working fluid flow for use with a vehicle.

### BACKGROUND

Thermal conditioning of a vehicle cabin in an electric or hybrid-electric vehicle can be more difficult than in a vehicle operating with a combustion engine since excess, waste, or by-product heat available from the propulsion system is limited. Some electric and hybrid-electric vehicles employ positive-temperature coefficient (PTC) heaters with ceramic components that vary in electrical resistance depending on operational temperatures. However, PTC heaters can be expensive and require high current levels and high power consumption in cold temperature environments, expending high levels of energy. Novel vehicle cabin configurations, such as a cabin configuration including opposed seats and an open interior, increase a thermal conditioning priority for occupants seated in a rear of the vehicle cabin as compared to occupants seated at a front of the vehicle cabin.

### SUMMARY

One aspect of the disclosed embodiments is a thermal control system for a vehicle. The thermal control system includes a first heat exchanger configured to thermally condition first intake airflow received at a first end of a vehicle cabin, a second heat exchanger configured to thermally condition second intake airflow received at a second end the vehicle cabin, a thermal loop circulating a working fluid between the first heat exchanger and the second heat exchanger, and a flow control system configured to cause the working fluid to circulate in opposite flow directions through the thermal loop for the first and second heat exchangers to operate in heating and cooling modes.

Another aspect of the disclosed embodiments is a thermal control system for a vehicle. The thermal control system includes a front module configured to thermally condition external intake airflow received from an exterior of a front end of the vehicle, a rear module configured to thermally condition rear intake airflow received from an interior of a vehicle cabin of the vehicle, a thermal loop circulating a working fluid between the front module and the rear module, and a flow control system configured to cause the working fluid to circulate in opposite flow directions through the thermal loop between the front and rear modules based on operating mode of the front and rear modules.

Another aspect of the disclosed embodiments is a thermal control system for a vehicle. The thermal control system includes a front module configured to thermally condition external intake airflow received from an exterior of a front end of the vehicle, a rear module configured to thermally condition rear intake airflow received from an interior of a vehicle cabin of the vehicle, and a blend partition configured to split the rear intake airflow into portions, wherein one of the portions follows a bypass path around a heat exchanger in the rear module and another of the portions follows a thermal conditioning path through the heat exchanger in the rear module.

### BRIEF DESCRIPTION OF THE DRAWINGS

FIG. 1 is an operational schematic of a thermal control system for use with a vehicle.

FIG. 2. is another operational schematic of the thermal control system of FIG. 1.

FIG. 3 is a schematic of dual-zone implementation for the thermal control system of FIGS. 1 and 2.

FIG. 4 is a schematic of a portion of a thermal control system for use with the vehicle.

FIG. 5 is a block diagram of a thermal control system.

FIG. 6 is an illustration showing a hardware configuration for a controller.

### DETAILED DESCRIPTION

Thermal control systems include front and rear modules with modifiable thermal conditioning functions that prioritize occupant comfort in a rear end of a vehicle cabin. Heat exchangers within the modules are configured to selectively operate as evaporators, gas coolers, or condensers based, at least in part, on a flow direction of working fluid in a thermal loop of the thermal control system. The flow direction is reversible to implement various heating and cooling modes. The thermal loop extends from the front or first module at a front of the vehicle cabin that includes a first heat exchanger to the rear or second module at a rear of the vehicle cabin that includes a second heat exchanger, an optional third heat exchanger, and recirculation and exhaust features.

The first heat exchanger in the front module is able to thermally condition airflow sourced from an external environment. The second and optional third heat exchangers in the rear module are able to thermally condition airflow sourced from the vehicle cabin to improve thermal comfort of any occupants seated in the rear of the vehicle cabin and improve operating efficiency of the thermal control system. The second and optional third heat exchangers can support recirculation back into the vehicle cabin and/or exhaust of the cabin-sourced airflow to an external environment. Operating modes for the thermal control system include heating, cooling, heat pump, cold pump, heating and heat pump, and cooling and cool pump.

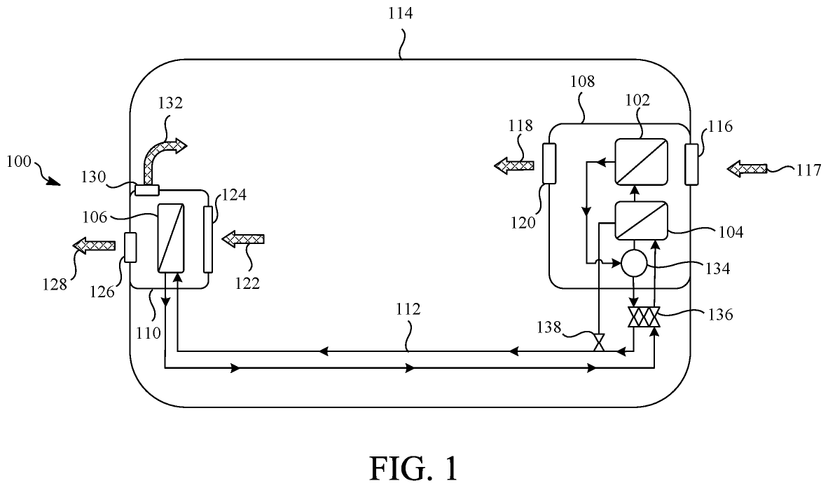

FIG. 1 shows an operational schematic of a portion of a thermal control system 100 for use with a vehicle. The thermal control system 100 includes heat exchangers 102, 104, 106. The heat exchangers 102, 104, 106 are shown as located within the modules 108, 110 and are coupled by a thermal loop 112 that includes arrows indicating a flow direction for an operational mode associated with the thermal control system 100. The modules 108, 110 and the thermal loop 112 are shown in respect to a vehicle cabin 114. A front module 108 is located at a first end, here, a front end of the vehicle cabin 114 that can seat rear-facing occupants (not shown) when the vehicle is traveling in a forward direction. A rear module 110 is located at a second end, here, a rear end of the vehicle cabin 114 that can seat front-facing occupants (not shown) when the vehicle is traveling in a forward direction.

The components are shown schematically, without ducts, vents, or other flow directing devices and without links to other thermal conditioning sources in order to describe various thermal conditioning processes implemented using this portion of the thermal control system 100. It is understood that the heat exchangers 102, 104, 106 can be higher in number, lower in number, arranged in different locations, or equipped with different features. For example, the heat exchangers 102, 106 can selectively operate as gas coolers, condensers, or evaporators depending on operational mode and depending on a direction of flow within the thermal loop. The heat exchanger 104 can include or comprise an accumulator. The components of the thermal control system 100, including any of the heat exchangers 102, 104, 106, can be in thermal communication with additional components (not shown), such as radiators, evaporators, condensers, chillers, or heat sources such as battery or powertrain components, in order to supplement and/or improve thermal conditioning performance of the thermal control system 100.

The thermal control system 100 includes a front inlet 116 associated with the front module 108 that receives external intake airflow 117 from an external environment surrounding the vehicle cabin 114. Airflows (including the external intake airflow 117) are represented using arrows with cross-hatched patterns. The external intake airflow 117 passes through the heat exchanger 102 for thermal conditioning to become front intake airflow 118 that passes through a front outlet 120 and into the vehicle cabin 114. Once in the vehicle cabin 114, the front intake airflow 118 mixes with air present within the vehicle cabin 114 to become rear intake airflow 122. The rear intake airflow 122 in the vehicle cabin 114 is pulled toward a rear inlet 124, for example, by a pressure differential or a fan or a blower (not shown) associated with the rear module 110. The rear intake airflow 122 passes through the rear inlet 124 and through the heat exchanger 106. Depending on operational mode, the rear intake airflow 122 can exit the vehicle cabin 114 through a rear outlet 126 as exhaust airflow 128, for example, back to the external environment, and/or re-enter the vehicle cabin 114 through a recirculation outlet 130 as recirculation airflow 132.

In the thermal control system 100 of FIG. 1, the thermal loop 112 can circulate a working fluid, such as refrigerant, between the heat exchangers 102, 104, 106. Circulation, evaporation, and condensation of the working fluid in the thermal loop 112 can be achieved using the heat exchangers 102, 104, 106 along with a flow control system that includes one or more compression devices 134 and one or more expansion devices or valves 136, 138. The one or more valves 136, 138 can be in separate locations at one end of the vehicle cabin 114 (as shown), can be located at opposite ends of the vehicle cabin 114 (not shown), or can be a single valve, such as with multiple ports, e.g., two ports, three ports, or four ports (not shown). The compression device(s) 134 can be configured to pressurize the working fluid in the thermal loop 112. The expansion device(s) or valves 136, 138 can be configured to de-pressurize and/or guide the working fluid in the thermal loop 112. Though the expansion device(s) and the valves 136, 138 are shown as integrated components, the two can be separate components in the thermal control system 100. Changes in pressure of the working fluid in the thermal loop 112 allow changes in temperature of airflow to be implemented using the heat exchangers 102, 104, 106.

The thermal control system 100 in FIG. 1 is shown in a heating mode where working fluid travels through the thermal loop 112 in a direction indicated by the arrows. The heat exchanger 102 selectively operates or functions as a gas cooler, a condenser, or combinations thereof to warm the external intake airflow 117 from the front inlet 116 that passes over or through the heat exchanger 102. The working fluid moves from the heat exchanger 102 to the compression device 134 before passing through the valve 136 and traveling from the front module 108 to the rear module 110. The working fluid then routes into and back out of the heat exchanger 106. In this heating mode, the heat exchanger 106 also selectively operates or functions as a gas cooler, a condenser, or combinations thereof, warming the rear intake airflow 122 that passes over the heat exchanger 106 from the rear inlet 124. The heated (i.e., re-heated) recirculation airflow 132 re-enters the vehicle cabin 114 through the recirculation outlet 130, efficiently warming a portion of the vehicle cabin 114 proximate to the rear module 110. The term “proximate” is used to indicate a position in front of, adjacent to, or next to the rear module 110. In this example, the rear outlet 126 would be closed, that is, there would be no exhaust airflow 128. The working fluid then returns from the rear module 110 to the valve 138, here, an ejector or expansion valve and travels into the heat exchanger 104 (for example, after the high side). Finally, the working fluid travels from the heat exchanger 104 to the heat exchanger 102, starting the cycle again.

The thermal control system 100 can also function as a heat pump, for example, in a cold environment. A heat pump circulates a working fluid, such as refrigerant, through cycles of evaporation or heating to absorb heat and condensation or cooling to release heat. To operate the thermal control system 100 in the heat-pump mode or configuration, the heat exchanger 102 selectively operates or functions as a gas cooler, a condenser, or combinations thereof to warm the external intake airflow 117 that enters the front module 108. In the heat-pump mode or configuration, the heat exchanger 106 is configured to cool or receive heat from the rear intake airflow 122 that passes across or through the heat exchanger 106 before exiting the vehicle cabin 114. To collect heat in this manner, the heat exchanger 106 selectively operates or functions as an evaporator. The heat collected or reclaimed from the rear intake airflow 122 can be put to other uses in the vehicle, including for continued use in optimizing performance of the thermal control system 100. In this example, the recirculation outlet 130 would be closed, and the rear intake air 122 that passes across or through the heat exchanger 106 would be cooled before passing through the rear outlet 126 to become exhaust airflow 128.

One benefit of operating the thermal control system 100 as a heat pump is improved durability in cold external environments. The heat exchanger 106 does not experience frost-and-thaw cycles since the rear intake airflow 122 passing through the heat exchanger 106 is generally warmer than the air in cold external environments. Avoiding frost-and-thaw cycles saves power and increases efficiency of the thermal control system 100. The heat-pump mode or configuration of the thermal control system 100 also controls humidity levels within the vehicle cabin 114. Further, reclaiming or collecting heat from the rear intake airflow 122 as it exits the vehicle cabin 114 as exhaust airflow 128 is especially useful in vehicles with hybrid or electric powertrains, since in contrast to vehicles with internal-combustion engines, little or no excess or waste heat is available from the powertrain for use by the thermal control system 100.

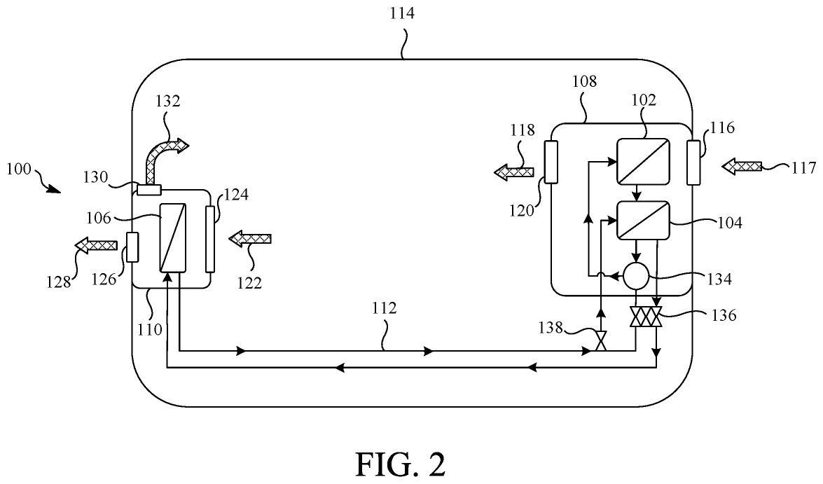

FIG. 2. shows another operational schematic of the thermal control system 100 of FIG. 1. The thermal control system 100 is configured to use the heat exchangers 102, 104, 106 and the flow control system that includes the compression device(s) 134 and the expansion device(s) and valves 136, 138 in conjunction with the thermal loop 112 to function in a cooling mode. In the cooling mode, the working fluid flows through the thermal loop 112 in a direction indicated by arrows. The flow direction of the working fluid shown in FIG. 2 is generally opposite to or a reverse of the flow direction of the working fluid shown in FIG. 1. By reversing flow direction in the thermal loop 112, that is, choosing or selecting a different flow direction, a lower number of heat exchangers (e.g., the heat exchangers 102, 104, 106) are required to implement both heating and cooling than in traditional thermal control systems with front and rear modules.

In the cooling mode of the thermal control system 100 useful in warm or hot external environments, the heat exchanger 102 selectively operates or functions as an evaporator to cool the external intake airflow 117 passing over or through the heat exchanger 102. The working fluid moves from the heat exchanger 102 to the heat exchanger 104, entering before a high side of the heat exchanger 104. The heat exchanger 104 provides a benefit in the cooling mode by supporting operation at a higher high-side pressure (e.g., above the critical point for carbon dioxide). After exiting the heat exchanger 104, the working fluid passes through the valve 136 and travels to the rear module 110. The working fluid then routes into and back out of the heat exchanger 106.

In the cooling mode, the heat exchanger 106 also selectively operates or functions as an evaporator, cooling the rear intake airflow 122 that passes over the heat exchanger 106 from the rear inlet 124. Thus cooled, the recirculation airflow 132 re-enters the vehicle cabin 114 through the recirculation outlet 130, cooling a portion of the vehicle cabin 114 proximate to the rear module 110. In this example, the rear outlet 126 would be closed, that is, there would be no exhaust airflow 128. The working fluid returns from the rear module 110 to the valve 138, then travels into the heat exchanger 104 (for example, before the low side and into an accumulator). The working fluid then travels from the heat exchanger 104 into the compression device 134. Finally, the working fluid travels from the compression device 134 to the heat exchanger 102, starting the cycle again.

The thermal control system 100 can also function as a cold pump. To operate the thermal control system 100 in the cold-pump mode or configuration, the heat exchanger 102 selectively operates or functions as an evaporator to cool the external intake airflow 117 to become the front intake airflow 118 that enters the vehicle cabin 114. The heat exchanger 106 can be configured to warm the rear intake airflow 122 that passes across or through the heat exchanger 106 while exiting the vehicle cabin 114. To reject heat in this manner, the heat exchanger 106 selectively operates or functions as a gas cooler, a condenser, or combinations thereof. The heat rejected to the rear intake airflow 122 can allow the cooled working fluid be put to other uses in the vehicle, including for continued use in optimizing performance of the thermal control system 100. In this example, the recirculation outlet 130 would be closed, and the exhaust airflow 128 would pass through the rear outlet 126.

In the cold-pump mode or configuration, the front intake airflow 118 can warm slightly within the vehicle cabin 114 as it becomes the rear intake airflow 122, but can also be cooler than ambient air in a warm or hot external environment. The rear intake airflow 122 can exit the vehicle cabin 114 through the rear inlet 124, pass across the heat exchanger 106 to cool the thermal loop 112, then exit the rear module 110 through the rear outlet 126 as exhaust airflow 128 to combine with warm ambient air in the external environment. A higher efficiency can be achieved for the thermal control system 100 by heating the rear intake airflow 122 that exits the vehicle cabin 114 as exhaust airflow 128. For example, rejecting heat from the thermal loop 112 to the rear intake airflow 122 supports lower power requirements for the compression device(s) 134 as a pressurized portion of the thermal loop 112 can be operated at a lower pressure.

The thermal control system 100 of FIGS. 1 and 2 has several benefits resulting from use of a working fluid that flows in opposite or reverse directions depending on operational mode. For example, the thermal control system 100 of FIGS. 1 and 2 has a lower number of heat exchangers and fewer lines running a length of the vehicle cabin 114 than traditional thermal control systems with front and rear portions, supporting a reduced vehicle mass and a lower component cost. In addition, the heat exchanger 106 in the rear module 110 is surrounded by the valves 136, 138 of the flow control system, and pressure inside the heat exchanger 106 can be controlled in a range between a discharge pressure of the compression device 134 and a suction pressure of the respective valve(s) 136, 138 located downstream of the heat exchanger 106 regardless of flow direction of the working fluid using the flow control system.

Another benefit of the thermal control system 100 is that the rear inlet 124 can be wide, extending, for example, across a large portion of a width (not shown) of the vehicle cabin 114, such as forty, fifty, sixty, or seventy percent of a width of the vehicle cabin 114. A wide rear inlet 124 supports more efficient operation of the thermal control system 100. For example, the thermal control system 100 provides better temperature control to occupants proximate to the rear module 110. Airflow from the front module 108 toward the rear module 110 is assisted by pressure differentials between the front outlet 120 and the rear inlet 124, reducing reliance on fans or blowers (not shown) to drive the airflow. Another benefit of the thermal control system 100 is improved durability in cold environments. The heat exchanger 106 does not experience frost-and-thaw cycles since the rear intake airflow 122 passing through the heat exchanger 106 is generally warmer than the air in cold environments since the rear intake airflow 122 is sourced from the vehicle cabin 114.

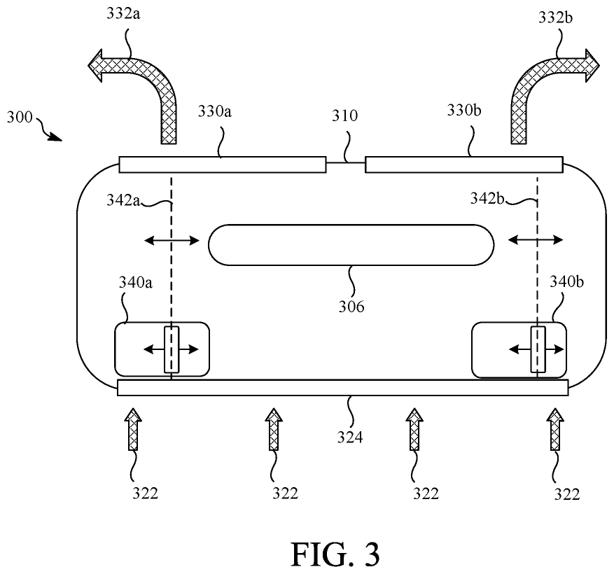

FIG. 3 is a schematic of dual-zone implementation for a thermal control system 300 similar to the thermal control system 100 of FIGS. 1 and 2. Since the thermal control systems 100, 300 are similar, only differences will be highlighted. A heat exchanger 306 is shown as disposed within a central portion of a module 310. The heat exchanger 306 is similar to the heat exchanger 106 of FIGS. 1 and 2 and can thermally condition rear intake airflow 322 received from a rear inlet 324. The rear inlet 324 can extended for a majority of a width of the module 310. The thermal control system 300 includes a pair of recirculation outlets 330a, 330b configured to direct recirculation airflows 332a, 332b (e.g., through ducts, doors, and/or vanes, not shown) to respective occupants situated, for example, on left and right sides of the module 310 within a vehicle cabin such as the vehicle cabin 114 of FIGS. 1 and 2. The recirculation airflows 332a, 332b include thermally conditioned portions of the rear intake airflow 322. That is, one portion of the rear intake airflow 322 feeds the recirculation airflow 332a and another portion of the rear intake airflow 322 feeds the recirculation airflow 332b. The portions of the rear intake airflow 322 in the example of FIG. 3 can be generally equivalent in size or volume, but can vary in other examples (not shown).

The use of separately controlled (here, dual) zones in the thermal control system 300 allows for a different speed and temperature for the recirculation airflow 332a as compared to the recirculation airflow 332b. The thermal control system 300 also includes a pair of mode controls 340a, 340b configured to control positioning of blend partitions 342a, 342b shown in dashed lines in a direction indicated by arrows. The blend partitions 342a, 342b are movable based on inputs to the mode controls 340a, 340b in order to change an amount or portion of the rear intake airflow 322 that follows a bypass path around the heat exchanger 306 as comparted to another amount or portion of the rear intake airflow 322 that follows a thermally-conditioned path through the heat exchanger 306 prior to the paths rejoining to become the recirculation airflows 332a, 332b.

The blend partitions 342a, 342b can be moved independently based on input(s) from one or more occupants to interfaces such as knobs, switches, dials, or other user interfaces associated with the mode controls 340a, 340b. In other words, input(s) from the one or more occupants can change a percentage, volume, size, amount, or portion of the rear intake airflow 322 that is directed to pass through the heat exchanger 306 and a percentage, volume, size, amount, or portion of the rear intake airflow 322 that is directed to bypass or flow around the heat exchanger 306 before being routed (e.g., by ducts, doors, and/or vanes, not shown) to the respective recirculation outlets 330, 330b to head back into the vehicle cabin 114 as the recirculation airflows 332a, 332b. The mode controls 340a, 340b can be independent or commonly controlled. The recirculation airflows 332a, 332b can be directed toward different occupants or toward different portions of the vehicle cabin 114.

In the example of FIG. 3, the blend partition 342a is associated with the mode control 340a and is positioned to bypass a larger portion of the rear intake airflow 322 than is being thermally conditioned by the heat exchanger 306. The blend partition 342b is associated with the mode control 340b and is positioned to bypass a smaller portion of the rear intake airflow 322 than is being thermally conditioned by the heat exchanger 306. In other words, the blend between bypassed and thermally-conditioned airflow differs in the recirculation airflows 332a, 332b, for example, to better suit occupant preferences. Though shown as right-side and left-side use of the heat exchanger 306 for simplicity, such as when airflow can be separately sent through left and right sides of the heat exchanger 306, multi-zone operation can be implemented in the thermal control system 300 using top and bottom portions of the heat exchanger 306 or multiple, smaller heat exchangers (not shown).

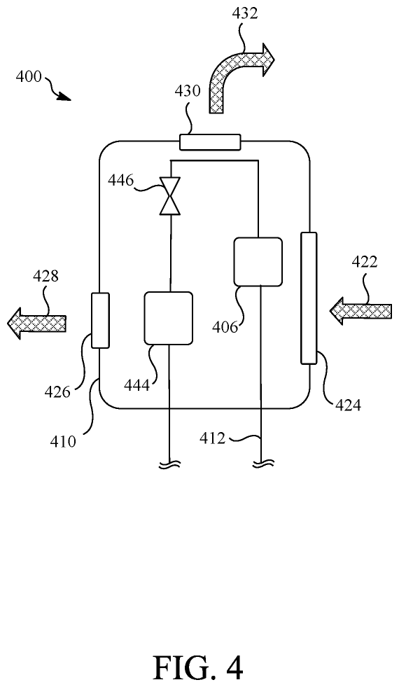

FIG. 4 is a schematic of a portion of a thermal control system 400 for use with the vehicle. Since the thermal control systems 100, 300, 400 are similar, only differences will be highlighted. Two heat exchangers 406, 444 are shown as disposed within a central portion of a module 410. The heat exchangers 406, 444 are similar to the heat exchangers 106, 306 of FIGS. 1, 2, and 3 and can thermally condition rear intake airflow 422 received from a rear inlet 424. That is, the module 410 can replace the rear module 110 of FIGS. 1 and 2. The rear inlet 424 can extended for a height larger than a height of the heat exchangers 406, 444, for example, to support various flow paths that bypass or flow through the heat exchangers 406, 444 (not shown). The thermal control system 400 includes a rear outlet 426 configured to direct exhaust airflow 428 and a recirculation outlet 430 configured to direct recirculation airflow 432 (e.g., through ducts, doors, and/or vanes, not shown) to occupants situated, for example, near the module 410 within a vehicle cabin such as the vehicle cabin 114 of FIGS. 1 and 2.

The thermal control system 400 also includes a thermal loop 412, shown as truncated, that can circulate a working fluid, such as refrigerant, between the heat exchangers 406, 444. The thermal loop 412 can be similar to the thermal loop 112 of FIGS. 1 and 2, extending, for example, from the module 410 to the front module 108 for fluid communication with the heat exchangers 102, 104, the compression device 134, and the expansion devices or valves 136, 138. The thermal control system 400 also includes an expansion device or valve 446 similar to the expansion devices or valves 136, 138 of FIGS. 1 and 2 along the thermal loop 412 between the heat exchangers 406, 444. The expansion device or valve 446 can be configured to de-pressurize and/or guide the working fluid in the thermal loop 412, for example, to support a reversal in flow direction through the thermal loop 412.

When comparing the thermal control system 400 to the thermal control system 100, the addition of the heat exchanger 444 can support smaller sizing for the heat exchangers 406, 444 as compared to the heat exchanger 106 in addition to allowing for additional operating modes for the thermal control system 400. For example, both of the heat exchangers 406, 444 can be configured to heat the rear intake airflow 422 for increased speed and capacity for warming. In another example, both of the heat exchangers 406, 444 can be configured to cool the rear intake airflow 422 for increased speed and capacity for cooling. One of the heat exchangers 406, 444 can be configured to heat the rear intake airflow 422 while the other of the heat exchangers 406, 444 is configured to cool the rear intake airflow 422 to support an operating mode where both dehumidification and heating are implemented.

The thermal control system 400 also supports combination modes, that is, heating or cooling a vehicle cabin, such as the vehicle cabin 114, while also operating a heat pump or a cold pump to improve efficiency of the thermal control system 400. To operate the thermal control system 400 in a heating and heat-pump mode or configuration, the heat exchanger 406 is configured to heat the rear intake airflow 422 that passes across or through the heat exchanger 406 before the rear intake airflow 422 re-enters the vehicle cabin through the recirculation outlet 430 as recirculation airflow 432. To heat in this manner, the heat exchanger 444 selectively operates or functions as a gas cooler, a condenser, or combinations thereof. In the same mode, the heat exchanger 444 is configured to cool or receive heat from the (portion of) the rear intake airflow 422 that passes across or through the heat exchanger 444 before exiting the rear outlet 426 as exhaust airflow 428. To collect heat in this manner, the heat exchanger 444 selectively operates or functions as an evaporator. Various ducts, doors, and flow paths that accomplish the combination mode of heating and heat pump are not shown.

To operate the thermal control system 400 in a cooling and cold-pump mode or configuration, and using a working fluid that flows a reverse direction (not shown) through the thermal loop 412 than for the heating and heat-pump mode or configuration, the heat exchanger 406 is configured to cool or receive heat from the rear intake airflow 422 that passes across or through the heat exchanger 406 before the rear intake airflow 422 re-enters the vehicle cabin through the recirculation outlet 430 as recirculation airflow 432. To cool in this manner, the heat exchanger 444 selectively operates or functions as an evaporator. In the same mode, the heat exchanger 444 is configured to heat the (portion of) the rear intake airflow 422 that passes across or through the heat exchanger 444 before exiting the rear outlet 426 as exhaust airflow 428. To heat in this manner, the heat exchanger 444 selectively operates or functions as a gas cooler, a condenser, or combinations thereof. Various ducts, doors, and flow paths that accomplish the combination mode of cooling and cold pump are not shown.

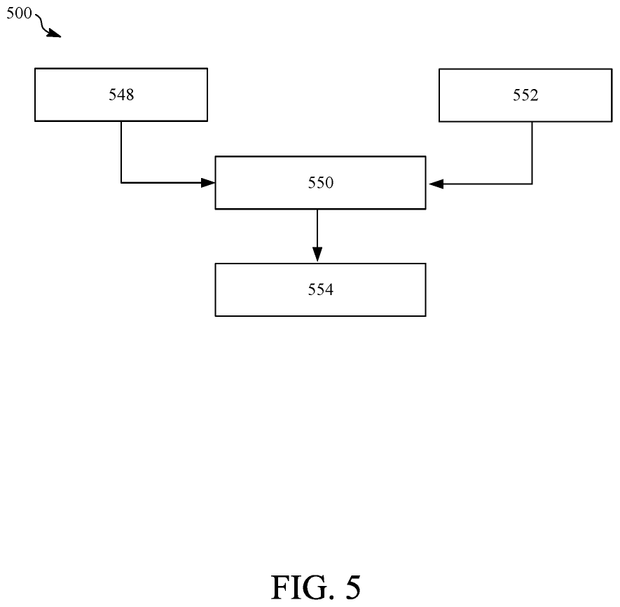

FIG. 5 is a block diagram that shows a thermal control system 500. The thermal control system 500 can include a user interface 548, a controller 550, sensors 552, and a heating, ventilation, and air conditioning (HVAC) module 554. The thermal control system 500 can operate in a manner similar to the thermal control systems 100, 300, 400 described in reference to FIGS. 1-4. The HVAC module 554 can include one or more housings, heat exchangers, flow paths, and/or doors that direct and condition intake airflow for the thermal control system 500.

The user interface 548 allows a user to modify aspects of the operation of the thermal control system 500 and to set operational modes for the HVAC module 554. For example, various operational modes can result in heating, cooling, recirculating, dehumidifying, or otherwise conditioning or reclaiming heat from intake airflows using the HVAC module 554. That is, the user interface 548 can allow modification of operating parameters of the HVAC module 554, for example, based on user preferences.

The controller 550 coordinates operation of the thermal control system 500 by communicating electronically (e.g., using wired or wireless communications) with the user interface 548, the sensors 552, and the HVAC module 554. The controller 550 may receive information (e.g., signals and/or data) from the user interface 548, from the sensors 552, and/or from other portions (not shown) of the thermal control system 500.

The sensors 552 may capture or receive information related, for example, to an external environment where the thermal control system 500 is located. The external environment can be an exterior or an interior of a vehicle or an office, and information captured or received by the sensors 552 can relate to temperature, humidity, airflow, or other ambient conditions within the vehicle or the office or exterior to the vehicle or the office.

The thermal control system 500 can change an operational mode of the HVAC module 554 based on a control signal, such as a signal from the controller 550. The control signal may cause the HVAC module 554 to vary blend partition or duct positions, airflow paths, airflow volumes, blower speeds, air temperatures, humidity levels, heat exchanger operation, etc. For example, a control signal can cause the HVAC module 544 to change from a first operational mode where rear intake airflow follows a flow path passing through an evaporator prior to entering a vehicle cabin and a second operational mode where rear intake airflow follows a flow path passing through a gas cooler prior to entering the vehicle cabin. Various technologies that may be used to implement the thermal control system 500 include thermal loops, heat exchangers such as condensers, resistance heaters, gas coolers, or evaporators, blowers or fans, compression devices, expansion devices such as nozzles or valves, ducts, vents, blend partitions, etc.

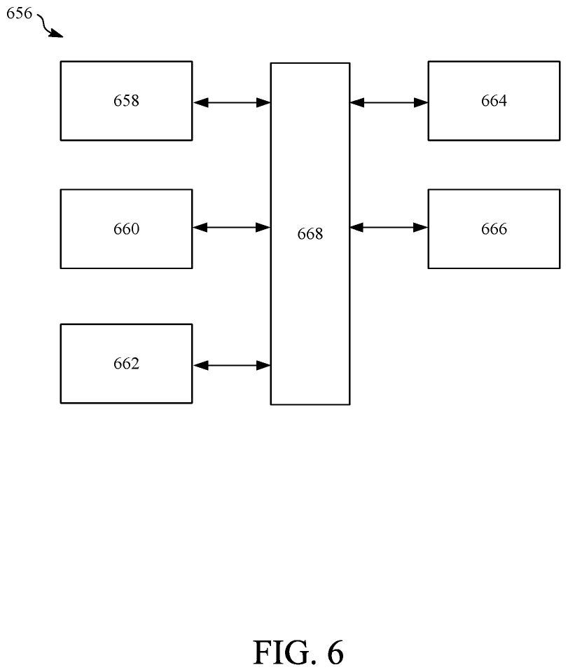

FIG. 6 shows an example of a hardware configuration for a controller 656 that may be used to implement the controller 550 and/or other portions of the thermal control system 500. In the illustrated example, the controller 656 includes a processor 658, a memory device 660, a storage device 662, one or more input devices 664, and one or more output devices 666. These components may be interconnected by hardware such as a bus 668 that allows communication between the components.

The processor 658 may be a conventional device such as a central processing unit and is operable to execute computer program instructions and perform operations described by the computer program instructions. The memory device 660 may be a volatile, high-speed, short-term information storage device such as a random-access memory module. The storage device 662 may be a non-volatile information storage device such as a hard drive or a solid-state drive. The input devices 664 may include sensors and/or any type of human-machine interface, such as buttons, switches, a keyboard, a mouse, a touchscreen input device, a gestural input device, or an audio input device. The output devices 666 may include any type of device operable to provide an indication to a user regarding an operating mode or state, such as a display screen, an interface for a thermal control system such as the thermal control systems 100, 300, 400, or an audio output.

As described above, one aspect of the present technology is the gathering and use of data available from various sources, such as from sensors 552 or user profiles, to improve the function of thermal control systems such as the thermal control systems 100, 300, 400. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of personal information data, in the present technology, can be used to the benefit of users. For example, the personal information data can be used to deliver changes to operational modes of thermal control systems to best match user preferences. Other uses for personal information data that benefit the user are also possible. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users.

Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of user-profile-based cabin temperature regulation through a thermal control system, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can be implemented without the need for accessing such personal information data. That is, the various embodiments of the present technology are not rendered inoperable due to the lack of all or a portion of such personal information data. For example, changes in operational modes in thermal control systems can be implemented for a given user by inferring user preferences based on non-personal information data, a bare minimum amount of personal information, other non-personal information available to the system, or publicly available information.

What is claimed is:

1. A thermal control system for a vehicle, comprising:
a first heat exchanger configured to thermally condition first intake airflow received at a first end of a vehicle cabin;
a second heat exchanger configured to thermally condition second intake airflow received at a second end the vehicle cabin;
a thermal loop circulating a working fluid between the first heat exchanger and the second heat exchanger; and
a flow control system configured to cause the working fluid to circulate in opposite flow directions through the thermal loop for the first and second heat exchangers to operate in heating and cooling modes.

2. The thermal control system of claim 1, wherein the second intake airflow is configured to re-enter the vehicle cabin through a recirculation outlet as recirculation airflow in the heating and cooling modes.

3. The thermal control system of claim 1, wherein the first and second heat exchangers selectively operate as one of an evaporator, a gas cooler, or a condenser based on the flow direction of the thermal loop.

4. The thermal control system of claim 1, wherein the first end is a front end of the vehicle cabin configured to seat rear-facing occupants when the vehicle is traveling in a forward direction, and wherein the second end is a rear end of the vehicle cabin configured to seat front-facing occupants when the vehicle is traveling in a forward direction.

5. The thermal control system of claim 1, wherein the first and second heat exchangers are configured to heat the first and second intake airflows in the heating mode, and wherein the first and second heat exchangers are configured to cool the first and second intake airflows in the cooling mode.

6. The thermal control system of claim 1, wherein the first heat exchanger is configured to heat the first intake airflow and the second heat exchanger is configured to cool the second intake airflow in a heat-pump mode.

7. The thermal control system of claim 6, wherein the second intake airflow is configured to exit the vehicle cabin through a rear outlet as exhaust airflow in the heat-pump mode.

8. The thermal control system of claim 1, wherein the first heat exchanger is configured to cool the first intake airflow and the second heat exchanger is configured to heat the second intake airflow in a cold-pump mode.

9. The thermal control system of claim 8, wherein the second intake airflow is configured to exit the vehicle cabin through a rear outlet as exhaust airflow in the cold-pump mode.

10. The thermal control system of claim 1, wherein the flow control system comprises:
a compression device disposed between the first heat exchanger and the second heat exchanger in the thermal loop, the compression device configured to pressurize a working fluid in the thermal loop; and
an expansion device disposed between the second heat exchanger and the first heat exchanger in the thermal loop, the expansion device configured to de-pressurize the working fluid in the thermal loop.

11. The thermal control system of claim 1, further comprising:
a blend partition configured to split the second intake airflow into portions, wherein one of the portions follows a bypass path around the second heat exchanger and another of the portions follows a thermal conditioning path through the second heat exchanger.

12. The thermal control system of claim 11, wherein the portions of the second intake airflow recombine to return to the vehicle cabin through a recirculation outlet as recirculation airflow.

13. The thermal control system of claim 11, further comprising:
a mode control configured to receive an input from one or more occupants and cause the blend partition to modify a size of the portions following the bypass path and the thermal conditioning path.

14. A thermal control system for a vehicle, comprising:
a front module configured to thermally condition external intake airflow received from an exterior of a front end of the vehicle;
a rear module configured to thermally condition rear intake airflow received from an interior of a vehicle cabin of the vehicle;
a thermal loop circulating a working fluid between the front module and the rear module; and
a flow control system configured to cause the working fluid to circulate in opposite flow directions through the thermal loop between the front and rear modules based on operating mode of the front and rear modules.

15. The thermal control system of claim 14, wherein the front module comprises a first heat exchanger and the rear module comprises a second and a third heat exchanger.

16. The thermal control system of claim 15, wherein the first, second, and third heat exchangers are configured to heat the external and rear intake airflows when the thermal control system operates in a heating mode, and wherein the rear intake airflow is configured to re-enter the vehicle cabin through a recirculation outlet as recirculation airflow in the heating mode.

17. The thermal control system of claim 15, wherein the first and second heat exchangers are configured to heat the external and rear intake airflows, respectively, and the third heat exchanger is configured to cool the rear intake airflow when the thermal control system operates in a heating and heat-pump mode, and wherein a portion of the rear intake airflow is configured to re-enter the vehicle cabin through a recirculation outlet as recirculation airflow and another portion of the rear intake airflow is configured to exit the vehicle cabin through a rear outlet as exhaust airflow when the thermal control system operates in the heating and heat-pump mode.

18. The thermal control system of claim 15, wherein the first, second, and third heat exchangers are configured to cool the external and rear intake airflows when the thermal control system operates in a cooling mode, and wherein the rear intake airflow is configured to re-enter the vehicle cabin through a recirculation outlet as recirculation airflow in the cooling mode.

19. The thermal control system of claim 15, wherein the first and second heat exchangers are configured to cool the external and rear intake airflows, respectively, and the third heat exchanger is configured to heat the rear intake airflow when the thermal control system operates in a cooling and cold-pump mode, and wherein a portion of the rear intake airflow is configured to re-enter the vehicle cabin through a recirculation outlet as recirculation airflow and another portion of the rear intake airflow is configured to exit the vehicle cabin through a rear outlet as exhaust airflow when the thermal control system operates in the cooling and cold-pump mode.

20. A thermal control system for a vehicle, comprising:
a front module configured to thermally condition external intake airflow received from an exterior of a front end of the vehicle;
a rear module configured to thermally condition rear intake airflow received from an interior of a vehicle cabin of the vehicle; and
a blend partition configured to split the rear intake airflow into portions, wherein one of the portions follows a bypass path around a heat exchanger in the rear module and another of the portions follows a thermal conditioning path through the heat exchanger in the rear module.

21. The thermal control system of claim 20, wherein the portions of the rear intake airflow recombine to return to the vehicle cabin through a recirculation outlet as recirculation airflow.

22. The thermal control system of claim 20, further comprising:
a mode control configured to receive an input from one or more occupants and cause the blend partition to modify a size of the portions following the bypass path and the thermal conditioning path.

23. The thermal control system of claim 20, wherein the front module includes a first heat exchanger, wherein the rear module includes a second heat exchanger, wherein a thermal loop circulates a working fluid between the first heat exchanger and the second heat exchanger, and wherein the first and second heat exchangers selectively operate as one of an evaporator, a gas cooler, or a condenser based on a flow direction of the thermal loop.
